(19) United States
(12) Patent Application Publication
(10) Pub. No.: US 2017/0240229 A1
(43) Pub. Date: Aug. 24, 2017

(54) SPROCKET WHEEL AND DRIVE SPROCKET FOR TRACK-TYPE MACHINE

(71) Applicant: Caterpillar Global Mining America L.L.C., Houston, PA (US)

(72) Inventor: Donald G. CORTESE, Washington, PA (US)

(73) Assignee: Caterpillar Global Mining America L.L.C., Houston, PA (US)

(21) Appl. No.: 15/048,628

(22) Filed: Feb. 19, 2016

(51) Int. Cl. B62D 55/125; B33Y 50/02; B33Y 10/00; G06F 17/50; B29C 67/00

(52) U.S. Cl. CPC B62D 55/125; G06F 17/50; B29C 67/0088; B33Y 10/00; B33Y 50/02; E21C 27/24

(57) ABSTRACT

A sprocket wheel for a track-type machine may include a base portion having a rotational axis about which the sprocket wheel rotates, and a plurality of teeth extending radially outward from the base portion. The teeth may include a tip, a first side wall extending radially inward from the tip toward the base portion, and a first transition portion extending from the first side wall. The sprocket wheel may also include a first flat extending from the first transition portion toward a second flat of a circumferentially adjacent tooth. The first and second flats may form an apex. The sprocket wheel may further include a relief surface extending radially inward from the apex, with the relief surface defining a concave surface having a longitudinal axis transverse with respect to a radial plane perpendicular to the rotational axis of the sprocket wheel.

### TECHNICAL FIELD

The present disclosure relates generally to a sprocket wheel and drive sprocket and, more particularly, to a sprocket wheel and drive sprocket for a track-type machine.

### BACKGROUND

In applications or environments where traction is critical or low ground pressure is important, machines propelled by an endless track may be used. Such track-type machines may include, for example, mining machines, dozers, excavators, and skid-steer loaders. These machines may typically include a frame that supports a power source, such as an internal combustion engine, and left and right undercarriage assemblies that transfer power from the power source to terrain on which the machine travels. The left and right undercarriage assemblies may be rigidly or pivotally mounted to the machine frame, and each of the undercarriage assemblies may include an undercarriage frame, a final drive coupled to a drive sprocket driven by the power source, and an idler wheel located at an end of the undercarriage frame remote from the drive sprocket. An endless track is looped around the drive sprocket and idler wheel, and during operation the drive sprocket rotates and engages links of the endless track, such that the endless track circulates around the drive sprocket and idler wheel, with the portion of the endless track adjacent the ground causing the machine to maneuver.

The repeated contact between the drive sprocket and the links during operation causes the drive sprocket teeth to wear and the endless track the lengthen, which can lead to the endless track slipping off the drive sprocket or idler wheel, or the endless track breaking. Repairing or replacing the drive sprocket or endless track may result in expensive and labor intensive maintenance, which reduces the operating time of the machine. Thus, reducing the wear on the drive sprocket and endless track may be desirable.

A system for installing roof support sheets first an underground mine is described in U.S. Pat. No. 8,936,415 B2 (“the '415 patent”) to Lugg et al., issued Jan. 20, 2015. Specifically, the '415 patent discloses a system for installing roof support sheets on a mine roof. The system includes a support frame, a lifting system, and a feeding system. The feeding system obtains at least one sheet from a lifting system and feeds the sheet toward an installation apparatus for installation on the mine roof The feeding system includes a drive assembly and a support. The drive assembly engages and moves the sheet toward an installation apparatus, and the support supports the sheet moved by the drive assembly. The drive assembly includes a chain drive including one or more sprockets that support a conveyor chain with rollers running on a support track. The sprockets can include eight teeth.

Although the system of the '415 patent includes a chain drive and sprockets, the system of the '415 patent does not address reducing the wear on a drive sprocket or endless tracks of a track-type machine. The sprocket wheel and drive sprocket disclosed herein may be directed to mitigating or overcoming one or more of the possible drawbacks set forth above.

### SUMMARY

According to a first aspect, a sprocket wheel for a track-type machine may include a base portion having a rotational axis about which the sprocket wheel rotates, and a plurality of teeth extending radially outward from the base portion. Each of the plurality of teeth may include a tip, a first side wall extending radially inward from the tip toward the base portion, and a first transition portion extending from the first side wall. The sprocket wheel may also include a first flat extending from the first transition portion toward a second flat of a circumferentially adjacent tooth. The first flat may have a radially outward facing surface configured to abut a portion of an endless track, and the first flat and the second flat form an apex. The sprocket wheel may further include a relief surface extending radially inward from the apex, with the relief surface defining a concave surface having a longitudinal axis transverse with respect to a radial plane perpendicular to the rotational axis of the sprocket wheel.

According to another aspect, a drive sprocket for a track-type machine may include a hub having a rotational axis about which the drive sprocket rotates, and a first sprocket wheel coupled to the hub. The first sprocket wheel may include a base portion having a rotational axis about which the first sprocket wheel rotates and a plurality of teeth extending radially outward from the base portion. Each of the plurality of teeth may include a tip, a first side wall extending radially inward from the tip toward the base portion, and a first transition portion extending from the first side wall. The first sprocket wheel may further include a first flat extending from the first transition portion toward a second flat of a circumferentially adjacent tooth, wherein the first flat has a radially outward facing surface configured to abut a portion of an endless track, and wherein the first flat and the second flat form an apex. The sprocket wheel may also include a relief surface extending radially inward from the apex, with the relief surface defining a concave surface having a longitudinal axis transverse with respect to a radial plane perpendicular to the rotational axis of the hub.

### BRIEF DESCRIPTION OF THE DRAWINGS

FIG. 1 is a perspective view of an exemplary embodiment of a track-type machine.

FIG. 2 is a partial section side view of an exemplary embodiment of an undercarriage assembly for a track-type machine.

FIG. 3 is a perspective view of an exemplary embodiment of a drive sprocket including an exemplary embodiment of a sprocket wheel.

FIG. 4 is a section view of an exemplary embodiment of a sprocket wheel.

FIG. 5 is a partial section side view of an exemplary embodiment of a drive sprocket engaging an exemplary embodiment of a track link.

FIG. 6 is a schematic view representing an exemplary system for generating a three-dimensional model of a sprocket wheel and/or a drive sprocket.

### DETAILED DESCRIPTION

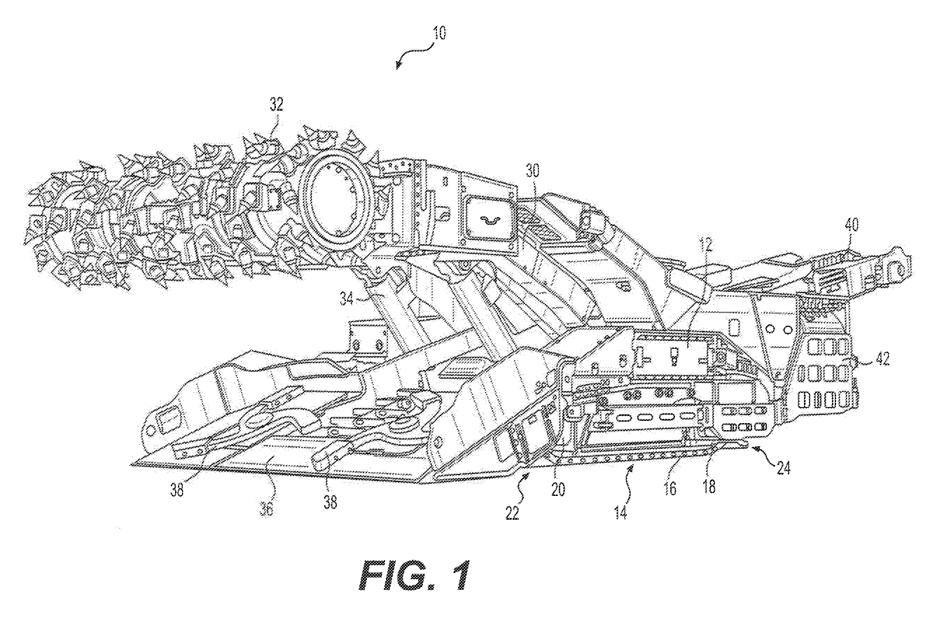

FIG. 1 is a perspective view of an exemplary embodiment of a track-type machine 10 showing portions of exemplary embodiments of a machine frame 12 and a pair of undercarriage assemblies 14 on opposing sides of machine 10. Exemplary machine 10 shown in FIG. 1 is a continuous mining machine configured to operate in subterranean mines. It should be noted, however, that the components and assemblies disclosed herein may be used with other types of track-type machines, such as, for example, dozers, excavators, track-type loaders, and skid-steer loaders.

In the exemplary embodiment shown, machine frame 12 is coupled to undercarriage assemblies 14, so that undercarriage assemblies 14 support machine frame 12. Each undercarriage assembly 14 includes an endless track 16, a drive sprocket 18, and an idler wheel 20. In the exemplary embodiment shown in FIG. 1, idler wheel 20 is located adjacent a front end 22 of endless track 16, and drive sprocket 18 is located adjacent a rear end 24 of endless track 16. Alternative arrangements are contemplated. Exemplary endless track 16 includes a plurality of track links 26 pivotally coupled to one another via track pins 28.

As shown in FIG. 1, exemplary machine 10 includes a boom 30 configured to support one or more work tools 32. For example, exemplary work tools 32 shown in FIG. 1 are cutter heads configured to scrape minerals from a mine seam. Machine 10 may also include one or more actuators 34 configured to raise and lower boom 30. Actuators 34 may be hydraulic, pneumatic, and/or electro-mechanical.

Exemplary machine 10 shown in FIG. 1 also includes a gathering head 36, which may include one or more loading arms 38. Loading arms 38 may be configured to rotate and push mined material collected in gathering head 36 into a conveyor 40 configured to transport the mined material for collection to a location remote from machine 10. Gathering head 36 may also include one or more hydraulic, pneumatic, and/or electro-mechanical actuators (not shown) configured to move gathering head 36 upward, downward, and/or laterally relative to a longitudinal axis of machine 10.

Machine 10 may also include a power source 42 configured to supply power to undercarriage assemblies 14 and endless tracks 16 via drive sprockets 18 to propel and maneuver machine 10 on the terrain. Power source 42 may be any suitable type of internal combustion engine, such as, for example, a gasoline engine, a compression-ignition engine, a natural gas engine, or power source employing hybrid operation. It is also contemplated that power source 42 may be electrically driven. According to some embodiments, power source 42 may be configured to deliver power output directly to drive sprockets 18. According to some, embodiments, power source 42 may be an internal combustion engine supplying power to a generator (not shown), which may drive one or more electric motors (not shown) coupled to drive sprockets 18. According to some embodiments, power source 42 may be configured to supply power to a hydraulic pump (not shown) fluidly coupled to a hydraulic motor (not shown) configured to convert fluid flow into a torque output, which may be coupled to drive sprockets 18. Power source 42 may also supply mechanical, electrical, and/or hydraulic power to actuators 34 to raise and lower boom 30, move gathering head 36, power conveyor 40, and/or power work tools 32 during operation of machine 10.

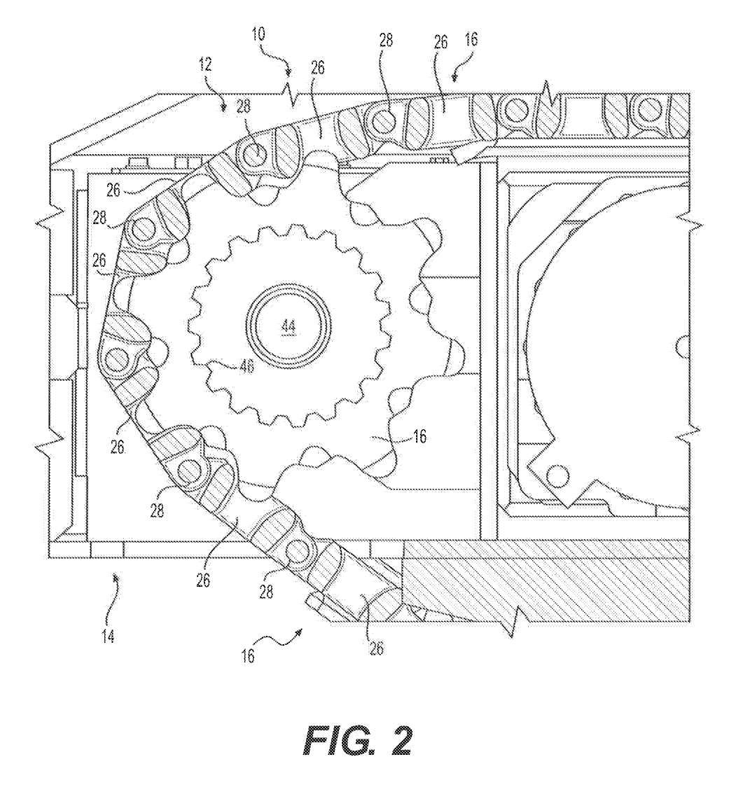

FIG. 2 is a section view of a portion of an exemplary undercarriage assembly 14 including an exemplary drive sprocket 18. in the exemplary embodiment shown, machine 10 includes a sprocket shaft 44 coupled to drive sprocket 18 via a splined coupling 46 configured to transfer torque between sprocket shaft 44 and drive sprocket 18. Other types of couplings configured to transfer torque are contemplated. It also is contemplated that undercarriage assemblies 14 may include additional and/or different components than those identified above. For example, undercarriage assemblies 14 may also include gear trains, seals, bearings, etc., that may cooperate to transfer the power output generated by power source 42 to drive sprocket 18.

As shown in FIGS. 2-5, drive sprocket 18 may include a hub 48 having a rotational axis R about which drive sprocket 18 rotates, Exemplary drive sprocket 18 also includes a first sprocket wheel 50 coupled to hub 48, such that hub 48 and first sprocket wheel 50 transfer torque between one another. In the exemplary embodiment shown, first sprocket wheel 50 includes a base portion 52 having a rotational axis co-linear with respect to rotational axis R of hub 48, about which first sprocket wheel 50 rotates.

Exemplary first sprocket wheel 50 also includes a plurality of teeth 54 extending radially outward from base portion 52, with teeth 54 being configured to engage track links 26 of endless track 16. For example, first sprocket wheel 50 may include eight teeth 54, as shown in FIGS. 2-4. By virtue of having eight teeth instead of, for example, six or seven teeth, first sprocket wheel 50 is able to distribute the load on first sprocket wheel 50 across more teeth and more of track links 26, thereby reducing the maximum stress on first sprocket wheel 50 and track links 26. This, in turn, may reduce the wear rate on first sprocket wheel 50 and/or track links 26, improving the service life of first sprocket wheel 50 and/or track links 26. According to some embodiments, first sprocket wheel 50 may include fewer or more teeth 54.

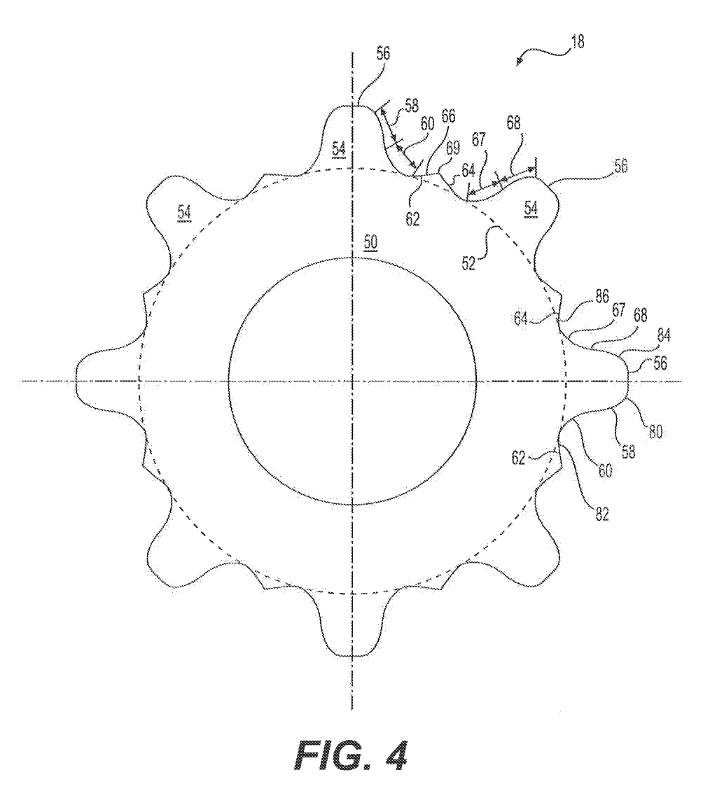

In the exemplary embodiment shown in FIGS. 2-5, one or more of teeth 54 (e.g., each tooth 54) includes a tip 56 and a first side wall 58 (FIG. 4) extending radially inward from tip 56 toward base portion 58. Teeth 54 may also include a first transition portion 60 extending from first side wall 58, and a first flat 62 extending from first transition portion 60 toward a second flat 64 of a circumferentially adjacent tooth 54, from which a second transition portion 67 extends radially outward toward a second side wall 68, which meets a second tip 56 of the circumferentially adjacent tooth 54. In the exemplary embodiment shown, first flat 62 has a radially outward facing surface 66 configured to abut a portion of endless track 16 (e.g., track links 26). As shown, first flat 62 and second flat 64 form an apex 69 as they approach one another from circumferentially adjacent teeth 54.

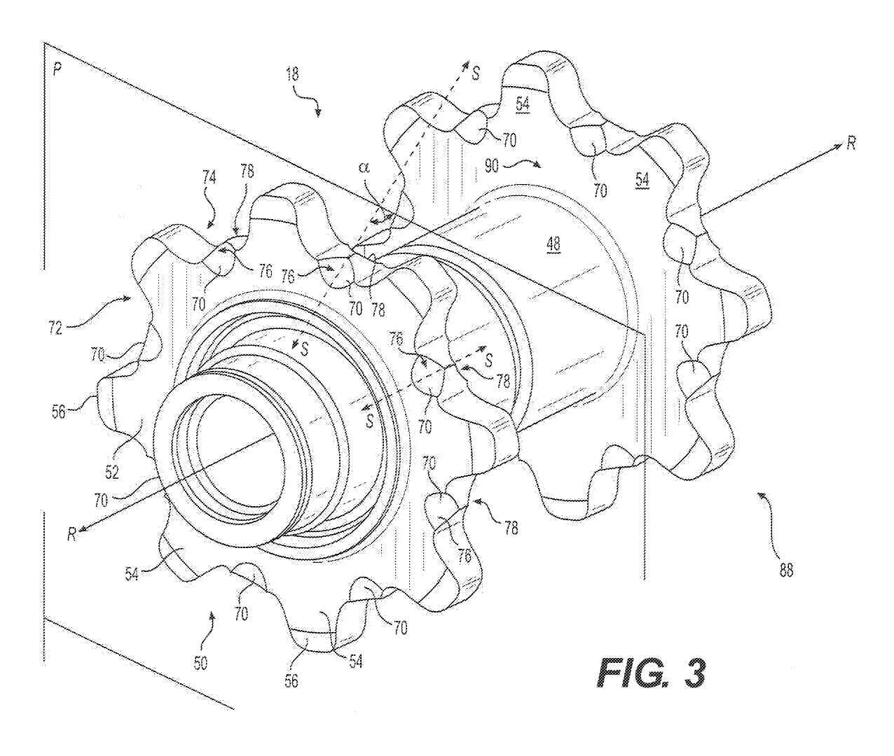

As shown in FIG. 3, exemplary first sprocket wheel 50 also include a relief surface 70 extending radially inward from apex 68. Exemplary relief surface 70 defines a concave surface having a longitudinal axis S transverse with respect to a radial plane P, which is perpendicular to rotational axis R of hub 48. For example, relief surface 70 may form an angle α relative to radial plane P ranging from 20 degrees to 70 degrees. For example, longitudinal axis S may lie in a plane parallel to and extending through rotational axis R, and angle α may lie in the same plane parallel to and extending through rotational axis R as longitudinal axis S. According to some embodiments, angle α may range from 25 degrees to 60 degrees, from 25 degrees to 50 degrees, from 25 degrees to 40 degrees, or from 25 degrees to 35 degrees (e.g., 30 degrees). According to some embodiments, relief surface 70 has a substantially constant radius relative to longitudinal axis S. For example, relief surface 70 may be formed as the surface of a cylinder have a center co-linear with longitudinal axis S. According to some embodiments, relief surface 70 may not have a substantially constant radius. For example, relief surface 70 may a segmented cross-section or a cross-section similar to half an ellipse or half an oval.

According to some embodiments, relief surface 70 may be configured to provide a passage through which material may flow as first sprocket wheel 50 engages track links 26 during maneuvering of machine 10. For example, as machine 10 maneuvers in a mine, material from the mine (e.g., mud, dirt, and rocks) may work its way between first sprocket wheel 50 and track links 26. such that as first sprocket wheel 50 transfers a portion of the weight of machine 10 and torque to track links 26, mine material grinds against first sprocket wheel 50 and track links 26, thereby inducing wear. Relief surface 70 provides a passage through which material may flow and prevent or reduce at least some of the induced wear.

First sprocket wheel 50 has a first axial side 72 transverse to rotational axis R and a second axial side 74 transverse to rotational axis and opposite first axial side 72. According to some embodiments, first sprocket wheel 50 includes a plurality of first relief surfaces 76 associated with first axial side 72 and a plurality of second relief surfaces 78 associated with second axial side 74. For example, first and second relief surfaces 76 and 78 may be located at a common circumferential position of first sprocket wheel 50. In the exemplary embodiment shown in FIG. 3, longitudinal axis S of first relief surfaces 76 and a longitudinal axis S of second relief surfaces 78 located at the same circumferential position intersect at a location radially outward of an associated apex 69. According to some embodiments, longitudinal axis S of first relief surfaces 76 and longitudinal axis S of second relief surfaces 78 located at the same circumferential position do not intersect.

According to some embodiments, one or more of tip 56, first side wall 58, first transition portion 60, first flat 62, apex 69, second flat 64, second transition portion 67, and second side wall 68 of teeth 54 may be surface-hardened to increase resistance to wear of teeth 54. For example, one or more of these portions of first sprocket wheel 50 may be surface-hardened so that the surface is more resistant to wear, while below the hardened surface of such portions is not hardened and remains less brittle than the surface-hardened portions. For example, one or more of these portions may be surface-hardened to a depth ranging from 0.25 inches to 0.75 inches, such as, for example, from 0.45 inches to 0.55 inches (e.g., 0.50 inches). Any known surface-hardening procedures may be used, such as, for example, induction hardening.

As shown in FIG. 4, some embodiments may be surface-hardened from a first point 80 close to the end of tip 56 along first side wall 58 and first transition portion 60 to a second point 82 on first flat 62, and from a third point 84 close to the end of tip 56 along second side wall 68 and second transition portion 67 to a fourth point 86 on second flat 64. This exemplary hardening results in the portions of teeth 54 transferring torque to track links 26 being more wear-resistant.

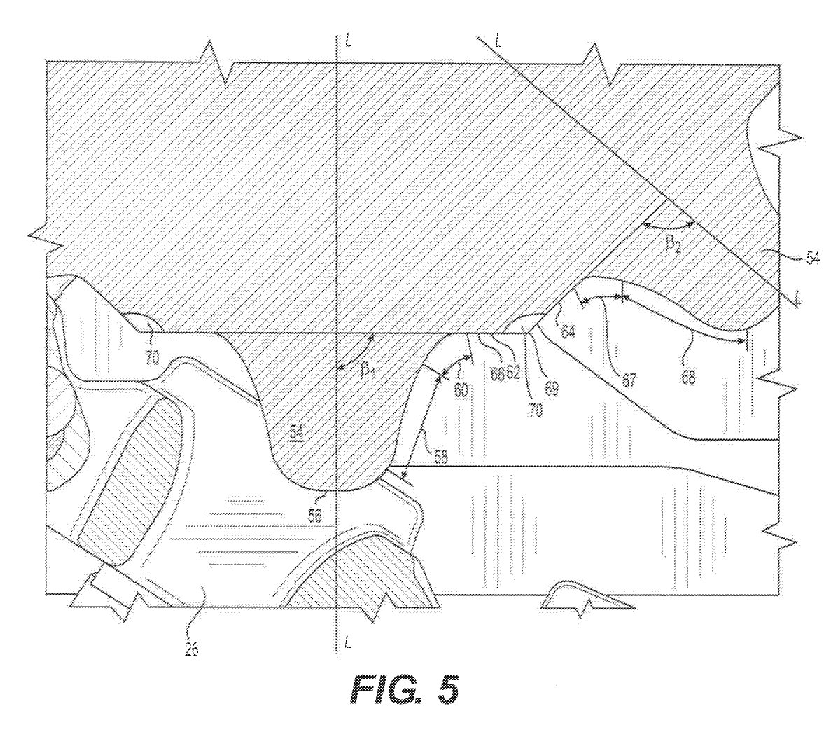

According to some embodiments, as shown in FIGS. 4 and 5, first flat 62 forms a first angle β₁ ranging from greater than 90 degrees to 100 degrees relative to a radially extending line L passing through rotational rotational axis R and tip 56 of a respective tooth 54, for example, such that line L bisects tip 56. For example, first angle β₁ may range from 90 degrees to 95 degrees, from 90 degrees to 93 degrees, or from 91 degrees to 92 degrees (e.g., 91.5 degrees). Similarly, second flat 64 may form a second angle β₂ ranging from greater than 90 degrees to 100 degrees relative to a radially extending line L passing through rotational axis R and a second tip 56 of a second respective tooth 54, for example, such that line L bisects tip 56. For example, second angle β₂ may range from 90 degrees to 95 degrees, from 90 degrees to 93 degrees, or from 91 degrees to 92 degrees (e.g., 91.5 degrees). First angle β₁ of first flat 62 and second angle β₂ of second flat 64 may be configured to provide improved engagement between teeth 54 and track links 26, which may result in reduced wear. According to some embodiments, first angle β₁ and second angle β₂ may be the same. According to some embodiments, first angle β₁ and second angle β₂ may be different.

As shown in FIGS. 2 and 5, the exemplary shape of tooth 54 may result in a leading edge of tooth 54 engaging track links 26 over a relatively wider surface area when drive sprocket 18 applies torque to endless track 16 in a first direction. Similarly the exemplary shape of tooth 54 may result in a trailing edge of tooth 54 engaging track links 26 over a relatively wider surface area when drive sprocket 18 applies torque to endless track 16 in a direction opposite the first direction. In addition, providing first and second flats 62 and 64 at slightly obtuse angles (i.e., first angle and second angle β₂) may result in first and second flats 62 and 64 engaging track links 26 over a relatively wider surface area of contact. Increasing the surface area of contact may result in reducing the stress on teeth 54 of drive sprocket 18 during operation of machine 10, which may result in reduced wear of teeth 54 and/or track links 26 of endless track 16.

As shown in FIG. 3, exemplary drive sprocket 18 also includes a second sprocket wheel 88 coupled to hub 48, for example, such that first and second sprocket wheels 50 and 88 are axially spaced from one another. According to some embodiments, second sprocket wheel 88 is substantially identical to first sprocket wheel 50. For example, second sprocket wheel 88 may include a second base portion 90 having a rotational axis co-linear with respect to rotational axis R of hub 48, about which second sprocket wheel 88 rotates, and a plurality of teeth 54 extending radially outward from second base portion 90. According to some embodiments, second sprocket wheel 88 is different than first sprocket wheel 50.

### INDUSTRIAL APPLICABILITY

Sprocket wheels 50 and drive sprockets 18 disclosed herein may be used in association with any track-type machine. For example, sprocket wheels 50 and/or drive sprockets 18 may be used with a continuous mining machine configured to operate in subterranean mines where ceilings may be low. In addition, sprocket wheels 50 and/or drive sprockets 18 may be used with other types of track-type machines, such as, for example, dozers, excavators, track-type loaders, and skid-steer loaders.

Sprocket wheels 50 may include relief surfaces 70 configured to provide passages through which material may flow as first sprocket wheel 50 engages track links 26 during maneuvering of machine 10 across terrain. Relief surfaces 70, according to some embodiments, may prevent or reduce at least some wear induced by mine material grinding against sprocket wheels 50 and endless track 16 as machine 10 maneuvers by providing passages through which material may pass, thereby reducing or preventing the build-up of material between sprocket wheels 50 and endless tracks 16.

Some embodiments of sprocket wheels 50 may be configured such that first flat 62 and/or second flat 64 form slightly obtuse angles (β₁ and β₂) relative to a radially extending line L passing through rotational axis R and tip 56 of a respective tooth 54. The slightly obtuse angles may result in first and second flats 62 and 64 engaging track links 26 over a relatively wider surface area of contact. Increasing the surface area of contact may result in reducing the stress on teeth 54 of drive sprocket 18 during operation of machine 10, which may result in reduced wear of teeth 54 and/or track links 26 of endless track 16.

Some embodiments of sprocket wheels 50 may include eight teeth 54 instead of, for example, six or seven teeth. As a result, sprocket wheel 50 is able to distribute load across more teeth and more of track links 26, thereby reducing the maximum stress on sprocket wheel 50 and track links 26. This, in turn, may reduce the wear rate on sprocket wheel 50 and/or track links 26, thereby improving the service life of sprocket wheel 50 and/or track links 26.

Some embodiments of sprocket wheel 50 may be at least partially surface-hardened. For example, one or more of tip 56, first side wall 58, first transition portion 60, first flat 62, apex 69, second flat 64, second transition portion 67, and second side wall 68 of teeth 54 may be surface-hardened to increase resistance to wear of teeth 54. For example, one or more of these portions of sprocket wheel 50 may be surface-hardened so that the surface is more resistant to wear, while the portion of sprocket wheel 50 below the hardened surface of such portions is not hardened and remains less brittle than the surface-hardened. portions. This may result in reduced wear rates of sprocket wheel 50.

The disclosed sprocket wheel and/or drive sprocket may be manufactured using conventional techniques, such as, for example, casting or molding. Alternatively, the disclosed sprocket wheel and/or drive sprocket may be manufactured using conventional techniques generally referred to as additive manufacturing or additive fabrication. Known additive manufacturing/fabrication processes include techniques, such as, for example, 3D printing. 3D printing is a process in Which material may be deposited in successive layers under the control of a computer. The computer controls additive fabrication equipment to deposit the successive layers according to a three-dimensional model (e.g., a digital file, such as an AMF or STL file) that is configured to be converted into a plurality of slices, for example, substantially two-dimensional slices, that each define a cross-sectional layer of the sprocket wheel and/or drive sprocket in order to manufacture, or fabricate, the sprocket wheel and/or drive sprocket, in one instance, the disclosed sprocket wheel and/or drive sprocket would be an original component, and the 3D printing process would be utilized to manufacture the sprocket wheel and/or drive sprocket. In other instances, the 3D process could be used to replicate existing sprocket wheels and/or drive sprockets, and the replicated sprocket wheels and/or drive sprockets could be sold as aftermarket parts. These replicated aftermarket sprocket wheels and/or drive sprockets could be either exact copies of the original sprocket wheel and/or drive sprocket or pseudo copies differing in only non-critical aspects.

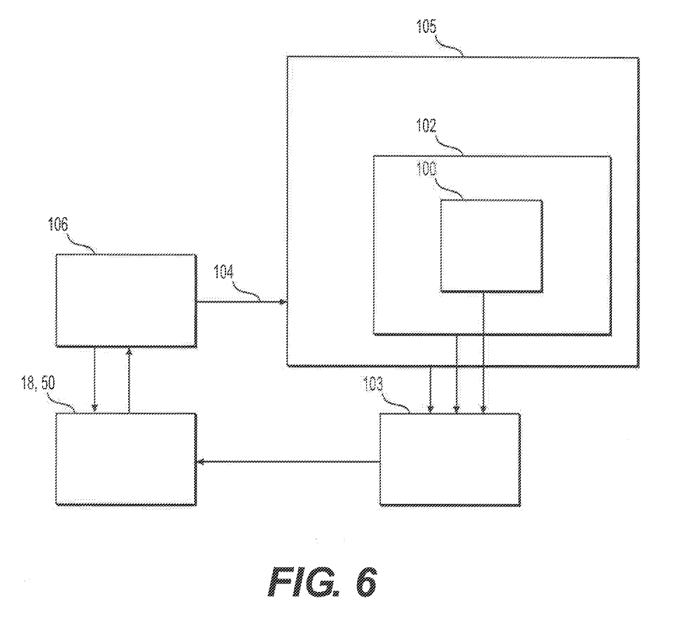

With reference to FIG. 6, the three-dimensional model 100 used to represent an original sprocket wheel and/or drive sprocket may be on a computer-readable storage medium 102, such as, for example, magnetic storage including floppy disk, hard disk, or magnetic tape; semiconductor storage such as, for example, a solid state disk (SSD) or flash memory; optical disc storage; magneto-optical disc storage; or any other type of physical memory on which information or data readable by at least one processor may be stored. This storage medium may be used in connection with commercially available 3D printers 103 to manufacture, or fabricate, the sprocket wheel and/or drive sprocket. Alternatively, the three-dimensional model may be transmitted electronically to the 3D printer 103 in a streaming fashion without being permanently stored at the location of the 3D printer 103. In either instance, the three-dimensional model constitutes a digital representation of the sprocket wheel and/or drive sprocket suitable for use in manufacturing the sprocket wheel and/or drive sprocket.

The three-dimensional model may be formed in a number of known ways. In general, the three-dimensional model is created by inputting data 104 representing the sprocket wheel and/or drive sprocket to a computer or a processor 105, such as a cloud-based software operating system. The data may then be used as a three-dimensional model representing the physical sprocket wheel and/or drive sprocket. The three-dimensional model is intended to be suitable for the purposes of manufacturing the sprocket wheel and/or drive sprocket. In an exemplary embodiment, the three-dimensional model is suitable for the purpose of manufacturing sprocket wheel and/or drive sprocket by an additive manufacturing technique.

In the exemplary embodiment shown in 6, the inputting of data may be achieved with a 3D scanner 106. The method may involve contacting the sprocket wheel and/or drive sprocket via a contacting and data receiving device, and receiving data from the contacting in order to generate the three-dimensional model. For example, 3D scanner 106 may be a contact-type scanner. The scanned data may be imported into a 3D modeling software program to prepare a digital data set. In some embodiments, the contacting may occur via direct physical contact using a coordinate measuring machine that measures the physical structure of the sprocket wheel and/or drive sprocket by contacting a probe with the surfaces of the sprocket wheel and/or drive sprocket in order to generate a three-dimensional model. In other embodiments, the 3D scanner 106 may be a non-contact type scanner, and the method may include directing projected energy (e.g., light or ultrasonic energy) onto the sprocket wheel and/or drive sprocket to be replicated and receiving the reflected energy. From this reflected energy, a computer may be used to generate a computer-readable three-dimensional model for use in manufacturing the sprocket wheel and/or drive sprocket. In various embodiments, multiple two-dimensional images may be used to create a three-dimensional model. For example, 2D slices of a 3D object may be combined to create the three-dimensional model. In lieu of a 3D scanner, the inputting of data may be performed using computer-aided design (CAD) software. In such instances, the three-dimensional model may be formed by generating a virtual 3D model of the disclosed sprocket wheel and/or drive sprocket using the CAD software. A three-dimensional model may be generated from the CAD virtual 3D model in order to manufacture the sprocket wheel and/or drive sprocket.

The additive manufacturing process utilized to create the disclosed sprocket wheel and/or drive sprocket may involve materials, such as, for example, plastic, rubber, metal, etc. In some embodiments, additional processes may be performed to create a finished product. Such additional processes may include, for example, one or more of cleaning, hardening, heat treatment, material removal, and polishing. Other processes necessary to complete a finished product may be performed in addition to or in lieu of these identified processes.

It will be apparent to those skilled in the art that various modifications and variations can be made to the exemplary disclosed sprocket wheel and/or drive sprocket. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. A sprocket wheel for a track-type machine, the sprocket wheel comprising:
a base portion having a rotational axis about which the sprocket wheel rotates;
a plurality of teeth extending radially outward from the base portion, wherein each of the plurality of teeth includes:
a tip;
a first side wall extending radially inward from the tip toward the base portion; and
a first transition portion extending from the first side wall;
a first flat extending from the first transition portion toward a second flat of a circumferentially adjacent tooth, wherein the first flat has a radially outward facing surface configured to abut a portion of an endless track, and wherein the first flat and the second flat form, an apex; and
a relief surface extending radially inward from the apex, the relief surface defining a concave surface having a longitudinal axis transverse with respect to a radial plane perpendicular to the rotational axis of the sprocket wheel.

2. The sprocket wheel of claim 1, wherein the sprocket wheel has a first axial side transverse to the rotational axis and a second axial side transverse to the rotational axis opposite the first axial side, and wherein the relief surface is a first relief surface associated with the first axial side, and the sprocket wheel further includes a second relief surface associated with the second axial side.

3. The sprocket wheel of claim 2, wherein the first and second relief surfaces are located at a common circumferential position of the sprocket wheel.

4. The sprocket wheel of claim 3, wherein the longitudinal axis of the first relief surface and a longitudinal axis of the second relief surface intersect at a location radially outward of the apex.

5. The sprocket wheel of claim 1, wherein the longitudinal axis of the relief surface is at an angle ranging from 20 degrees to 70 degrees relative to the radial plane.

6. The sprocket wheel of claim 1, wherein the relief surface has a substantially constant radius relative to the longitudinal axis.

7. The sprocket wheel of claim 1, wherein the first flat forms an angle ranging from greater than 90 degrees to 100 degrees relative to a radially extending line passing through the rotational axis and the tip of a respective tooth.

8. The sprocket wheel of claim 1, Wherein the sprocket wheel includes eight teeth.

9. The sprocket wheel of claim 1, wherein at least one of the tip, the first side wall, the first transition portion, and the first flat are surface-hardened.

10. A drive sprocket for a track-type machine, the drive sprocket comprising:
a hub having a rotational axis about which the drive sprocket rotates; and
a first sprocket wheel coupled to the hub, wherein the first sprocket wheel includes:
a base portion having a rotational axis about which the first sprocket wheel rotates;
a plurality of teeth extending radially outward from the base portion, wherein each of the plurality of teeth includes:
a tip;
a first side wall extending radially inward from the tip toward the base portion; and
a first transition portion extending from the first side wall;
a first flat extending from the first transition portion toward a second flat of a circumferentially adjacent tooth, wherein the first flat has a radially outward facing surface configured, to abut a portion of an endless track, and wherein the first flat and the second flat form an apex; and
a relief surface extending radially inward from the apex, the relief surface defining a concave surface having a longitudinal axis transverse with respect to a radial plane perpendicular to the rotational axis of the hub.

11. The drive sprocket of claim 10, further including a second sprocket wheel, wherein the first sprocket wheel and the second sprocket wheel are coupled to the hub such that the first and second sprocket wheels are axially spaced from one another.

12. The drive sprocket of claim 11, wherein the second sprocket wheel includes a base portion having a rotational axis about which the second sprocket wheel rotates, and a plurality of teeth extending radially outward from the base portion.

13. The drive sprocket of claim 10, wherein the first sprocket wheel has a first axial side transverse to the rotational axis and a second axial side transverse to the rotational axis opposite the first axial side, and wherein the relief surface is a first relief surface associated with the first axial side, and the first sprocket wheel further includes a second relief surface associated with the second axial side.

14. The drive sprocket of claim 13, wherein the first and second relief surfaces are located at a common circumferential position of the first sprocket wheel.

15. The drive sprocket of claim 14, wherein the longitudinal axis of the first relief surface and a longitudinal axis of the second relief surface intersect at a location radially outward of the apex.

16. The drive sprocket of claim 10, wherein the longitudinal axis of the relief surface is at an angle ranging from 20 degrees to 70 degrees relative to the radial plane.

17. The drive sprocket of claim 10, wherein the relief surface has a substantially constant radius relative to the longitudinal axis.

18. The drive sprocket of claim 10, wherein the first flat forms an angle ranging from greater than 90 degrees to 100 degrees relative to a radially extending line passing through the rotational axis and the tip of a respective tooth.

19. The drive sprocket of claim 10, wherein the first sprocket wheel includes eight teeth.

20. The drive sprocket of claim 10, wherein at least one of the tip, the first side wall, the first transition portion, and the first flat are surface-hardened.

21. A method of creating a computer-readable three-dimensional model suitable for use in manufacturing the sprocket wheel of claim 1, the method comprising:
inputting data representing the sprocket wheel to a computer; and
using the data to represent the sprocket wheel as a three-dimensional model, the three dimensional model being suitable for use in manufacturing the sprocket wheel.

22. The method of claim 21, wherein the inputting of data includes one or more of using a contact-type 3D scanner to contact the sprocket wheel, using a non-contact 3D scanner to project energy onto the sprocket wheel and receive reflected energy, and generating a virtual three-dimensional model of the sprocket wheel using computer-aided design (CAD) software.

23. A computer-readable three-dimensional model suitable for use in manufacturing the sprocket wheel of claim 1.

24. A computer-readable storage medium having data stored thereon representing a three-dimensional model suitable for use in manufacturing the sprocket wheel of claim 1.

25. A method for manufacturing the sprocket wheel of claim 1, the method comprising the steps of:
providing a computer-readable three-dimensional model of the sprocket wheel, the three-dimensional model being configured to be converted into a plurality of slices that each define a cross-sectional layer of the sprocket wheel; and
successively forming each layer of the sprocket wheel by additive manufacturing.
